(19) United States
(12) Patent Application Publication
(10) Pub. No.: US 2003/0116156 A1
(43) Pub. Date: Jun. 26, 2003

(54) Breathing apparatus

(76) Inventor: Peter J. Jackson, Sussex (GB)

Correspondence Address: Walter A. Rodgers, 880 North Island Drive, Atlanta, GA, 30327, US

(21) Appl. No.: 10/322,922

(22) Filed: Dec. 18, 2002

(30) Foreign Application Priority Data
Dec. 20, 2001 (GB) 0130487.2

(51) Int. Cl. A62B 18/00

(52) U.S. Cl. 128/201.22; 128/205.22; 128/201.28

(57) ABSTRACT

There is described a recharging valve for a breathing apparatus comprising a reservoir of breathable gas under pressure, a stop valve, a pressure reducing valve, and a facepiece for supplying gas to a wearer. The recharging valve comprises inlet means connectable to a supply of breathable gas at a pressure greater than that of the gas in the reservoir, outlet means for supplying gas from the inlet means to the reservoir, and valve means responsive to the pressure in the reservoir to control the flow of gas from the inlet to the outlet means.

This invention relates to self-contained breathing apparatus wherein breathable gas, stored under pressure in a reservoir carried by the wearer, is supplied to a face-piece, hood or helmet according to the wearer's needs.

Self-contained breathing apparatus are well known and vary widely in their design, construction and operational duration according to their intended application. The present invention relates particularly, but not exclusively, to breathing apparatus of the type commonly used by fire-fighters and other trained personnel engaged in entering and working within hazardous areas, such as burning buildings, where the atmosphere may be deficient in oxygen and contaminated by smoke and toxic gases. Under such hazardous working conditions, it is possible for persons to become trapped, injured or otherwise incapacitated such that they may be unable to return to a safe area before their air supply is depleted. In such circumstances, it may become necessary to provide the entrapped person with an extended air supply. The present invention provides an improved means whereby the breathing apparatus may be safely and effectively recharged with compressed air (or other breathable gas) whilst still in use, without compromising the integrity of the protection afforded to the wearer from the ingress of ambient atmosphere.

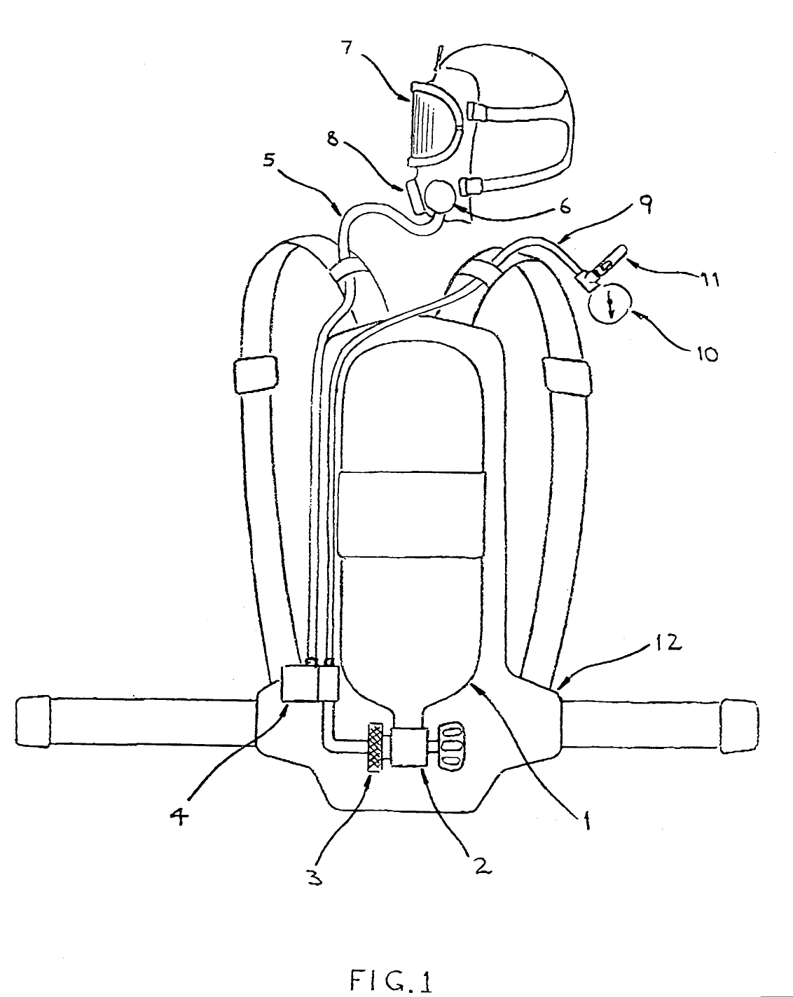

Conventional breathing apparatus is described in general terms with reference to FIG. 1 in which 1 is a high pressure reservoir, commonly referred to as a cylinder, fitted with a stop valve 2, to the outlet of which a coupling 3 attaches. To this coupling is connected a pressure regulating valve 4, which reduces the high pressure to a lower and substantially constant pressure which is fed, via a flexible hose 5 to a demand valve 6 connected to a face-piece 7 to which is also attached a spring loaded exhalation valve 8. The demand valve serves to admit air to the face-piece in accordance with the respiratory requirements of the wearer, by opening and closing in response to pressure variations within the face-piece caused by inhalation and exhalation, whilst at the same time maintaining a slight super-ambient pressure within the face-piece to prevent the ingress of ambient atmosphere in the event of leakage. A second hose 9 admits high pressure air from the cylinder to a pressure gauge 10 to allow monitoring of the air supply by the wearer. A whistle 11, or other form of alarm, operates to warn the wearer when his air supply has fallen to a pre-determined level. A back-plate and harness assembly 12 allows the cylinder to be carried on the wearer's back.

Normally, when such a breathing apparatus requires to be recharged with air, the coupling 3 is disconnected and the cylinder 1 is removed from the apparatus for charging or, for expediency, it may be replaced with a similar, already charged, cylinder. Due to design differences between models of breathing apparatus, varying sizes of cylinders and, most significantly, differences in working pressures, it is important that cylinders of different types are not interchanged. In order to prevent the interchanging of cylinders having a working pressure of 2,216 PSI with those working at 3,000 PSI or 4,500 PSI, the coupling 3 is made to be of a different design for each cylinder pressure.

It may be understood from the foregoing that extending the operational endurance of a breathing apparatus to enable the escape or rescue of an incapacitated wearer by replacing the depleted cylinder with a fresh one, could not be relied upon in practice. Also, the necessary interruption of the wearer's air supply and the likelihood of entraining ambient atmosphere would, in themselves, make such a method impracticable.

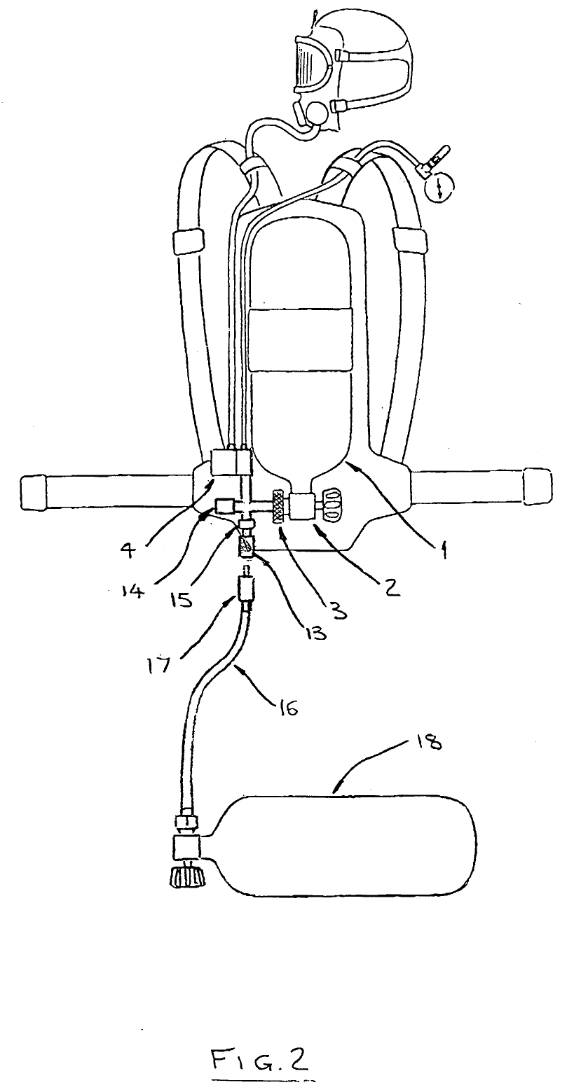

It has been proposed that all breathing apparatus used for fire-fighting be furnished with an additional high pressure connection means of a common design, to allow the recharging of the apparatus from an external source such as a high-pressure cylinder, without disconnection of the wearer's cylinder from the facepiece. In order to prevent the potentially very dangerous over-pressurisation of an apparatus designed to operate at a pressure lower than that being applied at the coupling by the external source, a pressure relief valve is required to be fitted. Such an arrangement is shown in FIG. 2 where, between the pressure regulating valve 4 and the coupling 3 to the cylinder valve 2, there are connected the high pressure charging coupling 13 and pressure relief valve 14. A non-return valve 15 may be added to prevent air flowing out of the apparatus when the charging cylinder is disconnected. By means of a high pressure hose 16 fitted with a mating coupling 17 and connected to a high pressure air source 18, the apparatus may be charged with air through coupling 13, the relief valve 14 serving to protect the wearer's cylinder from over-pressurisation by venting excess pressure to atmosphere. The coupling 13 is of the self closing type which shuts off when the mating coupling 17 is disconnected, thus preventing any loss of air from the apparatus or entry of ambient atmosphere.

The proposed arrangement shown in FIG. 2 has a number of limitations. The pressure relief valve 14, intended to protect the apparatus from over-pressurisation, must be set to open only when pressure within the apparatus exceeds the designed operating pressure by a significant margin, say 20% or more, in order to prevent seepage of air past the valve in normal usage, especially if the temperature of the cylinder is raised significantly above that at which it was fully charged, causing expansion of the air and, consequently, an increase in pressure within the cylinder. Also, if the external air source 18 is charged to a significantly higher pressure than the designed charging pressure of the apparatus then, unless care is taken when using such a source to charge the apparatus, a considerable loss of air through the relief valve 14 might occur. Such an escape of high pressure air is wasteful, and would generate a great deal of noise and possibly some confusion as a result.

It is the object of the present invention to improve upon the arrangement shown in FIG. 2 and provide a safe and effective method of protecting the breathing apparatus from over-pressurisation.

According to a first aspect of the invention, there is provided a recharging valve for a breathing apparatus comprising a reservoir of breathable gas under pressure, a stop valve, a pressure reducing valve, and a facepiece for supplying gas to a wearer, the recharging valve comprising, inlet means connectable to a supply of breathable gas at a pressure greater than that of the gas in the reservoir, outlet means for supplying gas from the inlet means to the reservoir, and valve means responsive to the pressure in the reservoir to control the flow of gas from the inlet to the outlet means.

The valve means preferably comprises a movable valve member which is resiliently biased toward an open position in which gas may flow from the inlet to the outlet means, and is urged toward a closed position by a pressure differential between ambient pressure and the pressure within the reservoir.

The recharging valve may also comprise a non-return valve to prevent gas from flowing from the outlet to the inlet means.

A second aspect of the invention provides a breathing apparatus comprising a reservoir of breathable gas under pressure, a stop valve, a pressure reducing valve, and a facepiece for supplying gas to a wearer, and a recharging valve comprising inlet means connectable to a supply of breathable gas at a pressure greater than that of the gas in the reservoir, outlet means for supplying gas from the inlet means to the reservoir, and valve means responsive to the pressure in the reservoir to control the flow of gas from the inlet to the outlet means.

A third aspect of the invention provides a method of recharging a breathing apparatus comprising a reservoir of breathable gas under pressure, a stop valve, a pressure reducing valve, and a facepiece for supplying gas to a wearer, and a recharging valve comprising inlet means connectable to a supply of breathable gas at a pressure greater than that of the gas in the reservoir, outlet means for supplying gas from the inlet means to the reservoir, and valve means responsive to the pressure in the reservoir to control the flow of gas from the inlet to the outlet means, the method comprising the steps of:

connecting a source of breathable gas at a pressure higher than the reservoir pressure to the inlet means of the recharging valve; and

supplying gas to the inlet means at said higher pressure until the pressure in the reservoir rises to close the valve means.

The source of breathable gas may be a gas cylinder, or a gas supply duct.

An embodiment of the invention will now be described in detail with reference to the accompanying drawings, in which:

FIG. 1 is a schematic rear view of a conventional breathing apparatus;

FIG. 2 is a schematic rear view of a conventional breathing apparatus recharging arrangement;

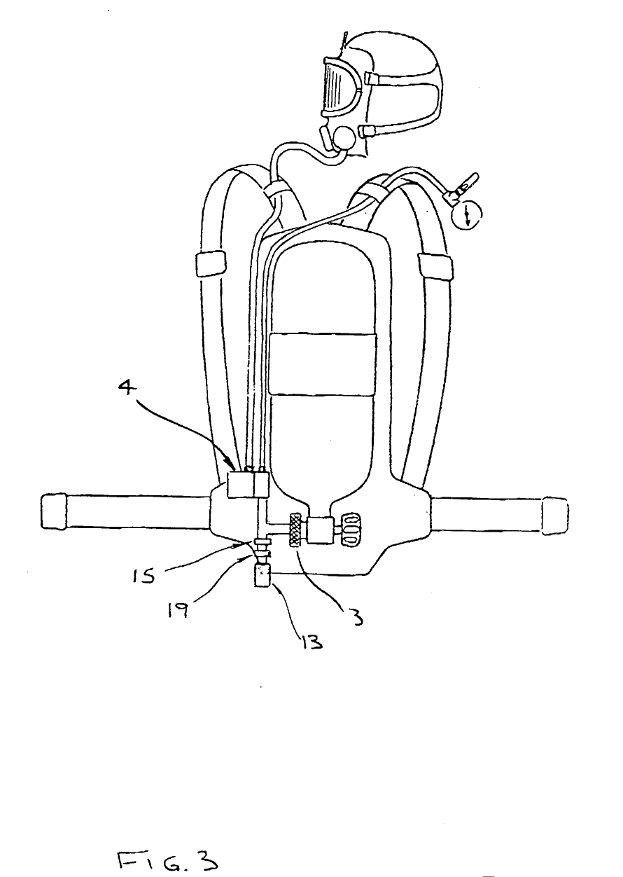

FIG. 3 is a schematic rear view of a breathing apparatus according to the invention; and

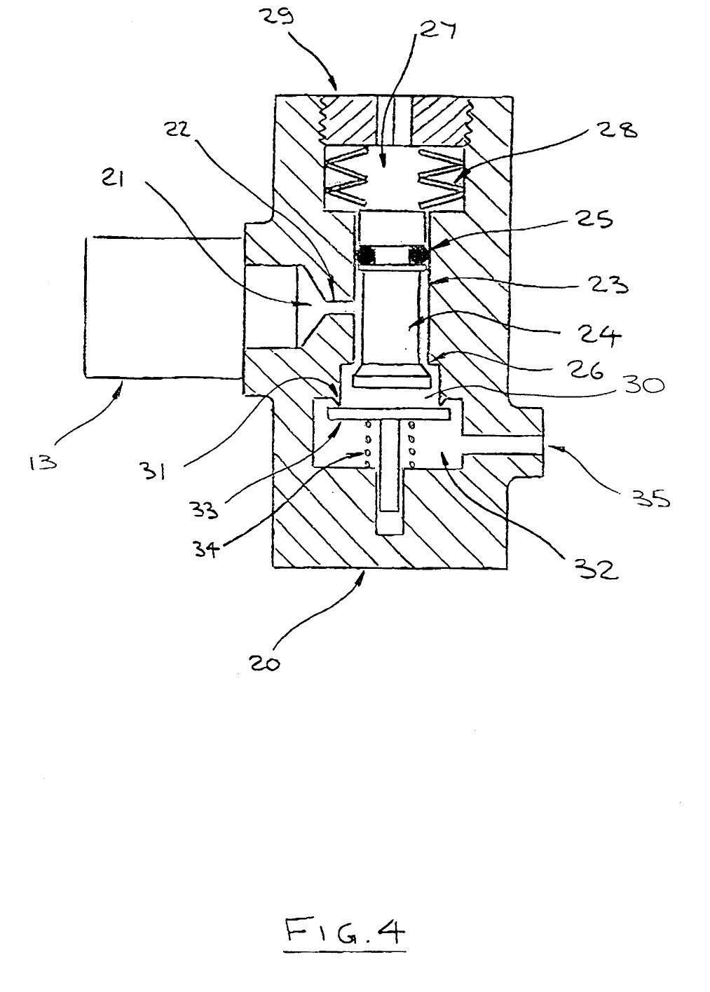

FIG. 4 is a schematic sectional view of a recharging valve according to the invention.

The objetive of the invention is achieved by the introduction of a safety pressure regulating valve which effectively isolates the charging coupling 13 when pressure in the breathing apparatus circuit reaches the designed operating pressure of the apparatus, so as to prevent any further air from entering through the charging coupling. With this arrangement, the pressure relief valve 14 may be dispensed with. Such an arrangement, according to the present invention, is shown in FIG. 3 where, between the cylinder valve coupling 3 and the pressure regulating valve 4, there are connected the charging coupling 13 and the safety charging pressure regulator 19. A non-return valve 15 may be incorporated to prevent air flowing out of the apparatus.

A preferred embodiment of the safety pressure regulator according to the present invention is shown in FIG. 4 in which 20 is the valve body having an inlet port 21 to which is connected the charging coupling 13 and an outlet port 35 which is in communication with the cylinder valve coupling 3 and the pressure regulating valve 4. The inlet port 21 communicates, via a restriction 22, with a bore 23 which houses a valve 24 in the form of a headed piston free to move axially in the bore 23. A seal 25, housed in a groove around the piston, seals the piston in the bore. A step in the piston bore provides a sealing edge 26, against which the conical head of the piston can seal. The opposite end of the piston is exposed to a chamber 27 which is in communication with ambient pressure and which houses a spring means 28, preferably formed from conical disc springs or Belleville washers as shown, and an adjustment means to adjust the precompression of the springs in the form of a threaded plug 29 bearing on the upper ends of the springs 28. The spring means 28 urges the piston downnwards (as seen in the Figure) such that the conical head of the piston is held away from the sealing edge 26, thus allowing communication between the piston bore 23 and the secondary bore 30. The secondary bore opens into a further bore or chamber 32 which is in communication with the outlet port 35 and which may house a non-return valve 33 which is held by a light biasing spring 32 against a sealing edge 31 formed in the body.

When the cylinder of the breathing apparatus is to be charged, connection is made between the external high pressure air source and the charging coupling 13. Air flows from the coupling through the restrictor 22, which limits the rate of flow, into the piston bore 23 and hence to the chamber 30 where the pressure of the incoming air urges the non-return valve 23 away from the sealing edge 13, allowing the air to flow into the chamber 32 and thence to the outlet port 35.

As the cylinder of the breathing apparatus fills with air, the rise in pressure is communicated from the outlet port 35 to the piston 24, urging it upwards against the spring means 28. The force applied by the spring means is pre-set so as to allow the conical head of the piston to close off and seal against the sealing edge 26 when pressure within the cylinder of the breathing apparatus is at the designed maximum charging pressure, thus preventing any further flow of air into the cylinder when that pressure has been reached.

If the external high pressure air source is left connected to the apparatus, as air is consumed by the wearer and pressure within the cylinder of the breathing apparatus subsequently falls, the piston 24 will move downwards to allow air to once again flow into the cylinder and maintain a fully charged condition.

It should be understood that the actual construction of the safety pressure regulating valve may differ from the preferred embodiment shown in and described with respect to FIG. 4.

1. A recharging valve for a breathing apparatus comprising a reservoir of breathable gas under pressure, a stop valve, a pressure reducing valve, and a facepiece for supplying gas to a wearer, the recharging valve comprising:
inlet means connectable to a supply of breathable gas at a pressure greater than that of the gas in the reservoir; outlet means for supplying gas from the inlet means to the reservoir; and
valve means responsive to the pressure in the reservoir to control the flow of gas from the inlet to the outlet means.

2. A recharging valve according to claim 1, wherein the valve means comprises a movable valve member which is resiliently biased toward an open position in which gas may flow from the inlet to the outlet means, and is urged toward a closed position by a pressure differential between ambient pressure and the pressure within the reservoir.

3. A recharging valve according to claim 1 or claim 2, further comprising a non-return valve to prevent gas from flowing from the outlet to the inlet means.

4. A breathing apparatus comprising:
a reservoir of breathable gas under pressure;
a stop valve;
a pressure reducing valve;
a facepiece for supplying gas to a wearer; and
a recharging valve comprising inlet means connectable to a supply of breathable gas at a pressure greater than that of the gas in the reservoir, outlet means for supplying gas from the inlet means to the reservoir, and valve means responsive to the pressure in the reservoir to control the flow of gas from the inlet to the outlet means.

5. A breathing apparatus according to claim 4, wherein the valve means of the recharging valve comprises a movable valve member which is resiliently biased toward an open position in which gas may flow from the inlet to the outlet means, and is urged toward a closed position by a pressure differential between ambient pressure and the pressure within the reservoir.

6. A breathing apparatus according to claim 4 or claim 5, wherein the recharging valve further comprises a non-return valve to prevent gas from flowing from the outlet to the inlet means.

7. A method of recharging a breathing apparatus comprising a reservoir of breathable gas under pressure, a stop valve, a pressure reducing valve, and a facepiece for supplying gas to a wearer, and a recharging valve comprising inlet means connectable to a supply of breathable gas at a pressure greater than that of the gas in the reservoir, outlet means for supplying gas from the inlet means to the reservoir, and valve means responsive to the pressure in the reservoir to control the flow of gas from the inlet to the outlet means, the method comprising the steps of:
connecting a source of breathable gas at a pressure higher than the reservoir pressure to the inlet means of the recharging valve; and
supplying gas to the inlet means at said higher pressure until the pressure in the reservoir rises to close the valve means.

8. A method according to claim 7, wherein the source of breathable gas is a gas cylinder.

9. A method according to claim 7, wherein the source of breathable gas is a gas supply duct.

10. A recharging valve for a breathing apparatus substantially as hereinbefore described with reference to FIG. 4 of the accompanying drawings.

11. A breathing apparatus substantially as hereinbefore described with reference to FIGS. 3 and 4 of the accompanying drawings.

12. A method of recharging a breathing apparatus substantially as hereinbefore described.
